(19) United States
(12) Patent Application Publication
(10) Pub. No.: US 2012/0185382 A1
(43) Pub. Date: Jul. 19, 2012

(54) Pay by link system and method

(76) Inventor: Mark Noyes Fischer, Boulder, CO (US)

(21) Appl. No.: 12/930,902

(22) Filed: Jan. 19, 2011

(51) Int. Cl. G06Q 40/00

(52) U.S. Cl. 705/40

(57) ABSTRACT

A new method and system for enabling payment via a simplified web link, such as a uniform resource locator, is provided. The human readable web link allowing for easy understanding and interpretation by a customer is generated in response to the receipt of a financial transaction between a customer and a merchant. Responsive to receipt of the generated web link, the system creates a customized customer payment page that only requires entry of credit card or other details by a customer. The submitted financial information is passed to a payment gateway for processing and, responsive to successful transaction, a payment confirmation message is sent to the merchant and customer.

### RELATED APPLICATIONS

This application claims priority of co-pending U.S. Pat. No. 6,847,304 titled “Pay By Link System and Method” as invented by Mark Noyes Fischer that was filed on Jan. 20, 2010. That application is here by incorporated by reference in its entirety.

### FIELD OF THE INVENTION

This invention relates to the field of electronic payment systems.

### BACKGROUND OF THE INVENTION

Online payment systems have been around for many years. Most vendors and services providers use their own specialized payment pages to collect information on the payment methods—such as the collection of Visa numbers and expiration dates—that require a user to create an account, select the amount to be paid, and submit payment. Not only is this inconvenient for the user but it also risks having the pay or selecting the wrong amount to be paid. In addition, at the end of each month as a new invoice becomes due, the user must remember their prior login and security password in order to pay again.

Similarly, for the payee, sending out invoices and hoping that the client or customer goes to the payment page, registers, enters their correct payment data and enters the correct invoice amount is a problem. In particular, such an approach requires multiple steps and online commerce experts know that each additional step reduces the likelihood of completing that transaction. Second, such an approach creates an administration hurdle, as the payee must manage a database of payment information as well as user accounts. Finally, the same invoicing system used by the merchant is not linked to the online payment system making accounting management of invoicing and customer payment a double entry hurdle.

Alternative payment systems, such as Paypal™, have tried to simplify the payment process by permitting any payment to be “pushed” via an email address but this creates several potential concerns. First, there is the fact that the request must be pushed from within their system. This makes it almost impossible to generate the payment request from a third party billing system directly. Next, there is a potential concern for mistakenly entering the wrong email address or vendor. An incorrect entry of an email may mean paying the wrong person. Thirdly, the recipient must then match the payment back to their original invoice. Finally, there is a chance of entering the wrong payment amount.

What is needed then, is a system and method for generating an invoice that includes the vendor information and payment terms. This will create a user friendly payment page which facilitates faster and more accurate payment processing. The payment page can be integrated into a financial back-end system that is hosted by the merchant or their designated service provider. Upon basic system setup, payment requests could be sent from any number of systems (be they sub systems or independent systems connected loosely through this invention), resulting in both flexibility of platform and communication modality as well as increased accuracy of requested payment parsing and processing.

### SUMMARY OF THE INVENTION

The system and method of the current system provides a means for providing a user with payment link in which the vendor, invoice number, amount and all other transactional details can be represented in a single Uniform Resource locator (URL) Such that the payment link can be drafted in an easy to understand way and, upon clicking by a user on an appropriate computing device, can generate a payment page that can facilitate immediate payment. Furthermore, upon payment, the system of the present invention can link such payment to the back end accounting system of the merchant. The system facilitates great ease of accounting as well as more accurate bookkeeping.

The system is comprised of four primary components: a computing device (such as a personal computer) with a browser capable of retrieving digital information responsive to the entry of one or more URLs, a web server for receiving a URL request from the user, a Grammatical Monitory Request Management System (GMRMS) for parsing the URL into a payment request by extracting payment, invoice, user and merchant information as applicable, and a payment gateway for executing a payment responsive to user entry of credit card or other data.

The system may further include additional subsystems such as a messaging system that can notify the user and/or merchant of the success of the requested payment transaction, an accounting system for managing merchant invoicing and related financial information and/or a connector to an alternative accounting system managed by the merchant or their designated provider. For example, the merchant could use an online or offline accounting system such as Quicken™ Online, Freshbooks™, or an other accounting system that is capable of generating an invoice in PDF or other formats. Collectively, several of these subsystems are known as a merchant system, and may include a merchant interface(s) and a Secure API. In at least one other embodiment, the system may include reporting systems, invoicing systems, batch summary systems, and other related features.

Finally, the present system may also include general user interface (GUI) functionality that permits a merchant to modify the appearance of the payment page generated responsive to the URL, as well as any invoices or other documents that are exchanged with the customer as part of the overall payment process of the current system.

While this section provided a high level summary of the present invention, it will be appreciated that the system is comprised of many potential aspects and components each of which will be further described in greater details with reference to the drawings below.

### BRIEF DESCRIPTION OF THE DRAWINGS

FIG. 1 is a block diagram illustrating a computer network that may be utilized to implement the present invention.

FIG. 2 is a newly formatted uniform resource locator that is configured to enable the one-click payment process of the present invention.

FIG. 3 is an example setting forth the message/notification delivery platforms that can be utilized by the present invention.

FIG. 4 illustrates use of the unique URL of the present invention in an email-based invoicing system.

FIG. 5 provides a sample invoice that could be generated that combines the merchant invoice with the unique URL of the present invention.

FIG. 6 provides a sample payment page that could either be retrieved or dynamically generated by a web server responsive to a request that uses the unique URL of the present invention.

FIG. 7 provides a flowchart illustrating the payment method of the present invention.

### DETAILED DESCRIPTION OF EXAMPLE EMBODIMENTS

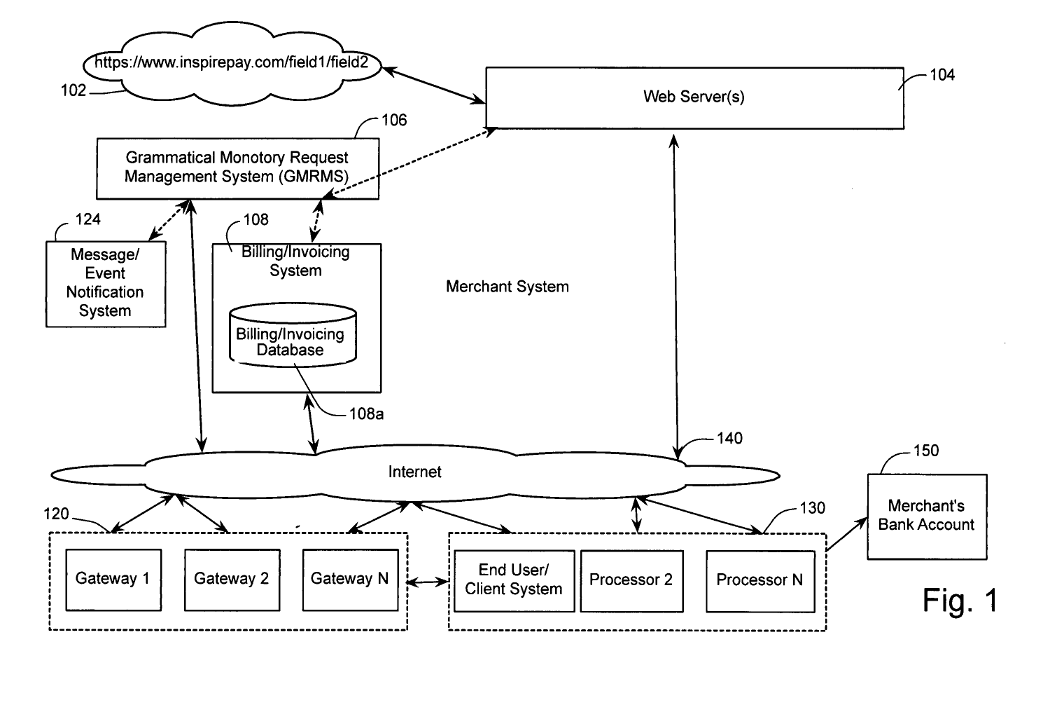

FIG. 1 shows a block diagram of a computer network that may be used for implementing various aspects of the present invention in accordance with a specific embodiment.

Section 102 refers to a browser 102 or other connection software that enables a consumer to enter one or more Uniform Resource Locators (URLs) of the present invention for submission to the web server 104. While the browser software 102 will be described with reference to a consumer sitting at a personal computer using a web browser, any HTTP client run on enabled computing device (such as a smartphone or other mobile computing device) that can retrieve content via one or more URLs could be used. This would include devices such as a cellphone/smartphone, a kiosk, a gaming device, or any other electronic device that can communicate with a server via the Internet 140. Sample embodiments of this URL could include a link in an e-mail, in a tweet, in a Facebook post, or any number of other messaging platforms that support dynamic link creation and sharing.

A web server 104 is also provided. A web server is a program that, using the client/server model and the World Wide Web's Hypertext Transfer Protocol (HTTP), serves the files that form Web pages to users (whose computers contain HTTP clients that forward their requests). Every computer on the Internet that contains a Web site must have a Web server program. Two leading Web servers are Apache, the most widely-installed Web server, and Microsoft's Internet Information Server (IIS). The server 104 may be running on one of many operating systems, and may be supporting one of many web applications. Additionally, the web server 104 of the present invention may be located in a single integrated system architecture with the other illustrated components or may be an external web server 104 (hosted by a merchant for example) that is in remote communication with the other components of FIG. 1.

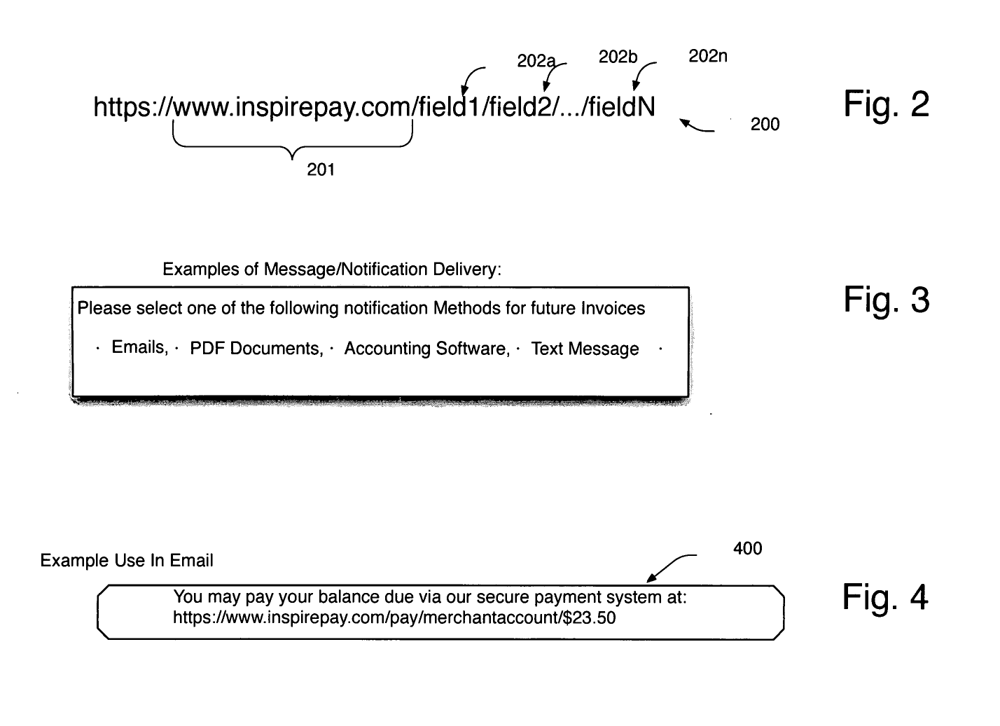

FIG. 1 further includes the Grammatical Monitory Request Management System (GMRMS) 106. The GMRMS 106 is a software application, which may be running on a web server, interne enabled computer device, self-contained hardware solution, or other device. THE GMRMS 106 is configured to receive URL requests sent by browser 102 or other connection software 102 via the web server 104 and parse the data according to it's originating request. For example, in one embodiment, the URL would include an indication of the merchant to be paid, the amount to be paid, an invoice #, and other fields often used in invoice or other payment processing. These are illustrative only as additional sample fields and layouts are further described with reference to FIG. 2.

The GMRMS 106 parses the URL to determine the correct environment for those using the client-merchant invoicing URL to continue processing the merchant's request. For example, data stored in the GMRMS 106, or connected to the GMRMS 106 directly through a database may include detailed merchant information including contact information, processor data, payment gateway location, and API keys for interfacing with one or more Secure API Interfaces 114 (if applicable), payment histories, and other related data that would be needed to perform the payment process being requested via the URL.

The GMRMS could also push data to the consumer or to the merchant in response to a URL. For example, the GMRMS could provide the customer with payment forms, merchant data, amount being requested, and other such data. Similarly, data sent from the GMRMS to the processor 130 and/or payment gateway(s) 120 may include customer data, such as billing and shipping address, amount paid, card data, invoice numbers, comments, and other related data. In at least one embodiment, the GMRMS 106 may be triggered by an inbound client invoice URL request, in system chron. cycles, client/merchant system logins, or any number of other potential triggering events.

The GMRMS 106 may further interact with several sub systems and adjacent systems, including a message/event notification system 124. In at least one potential embodiment, a notification system 124 could be used to communicate information to account managers, merchant systems, customers, and/or merchants. These may include text messages, emails, phone calls, API calls, and other communication modalities. Information sent via the notification system could further include sales totals, sales completions, outstanding invoices due, and other data.

Billing/Invoicing Systems as seen in one potential embodiment in section 108, may include every modern day accounting/billing/invoicing system that allows for email, pdf, and/or paper invoices, as well as other communications methods. Traditionally the function of such a system 108 may be for managing company books, invoicing customers, or other functions. Typically, data stored in the billing/invoicing system 108 may include custom data, sales figures, sales histories, and other financial data. One example embodiment may include the ability to generate a customer-merchant invoicing request to be included in a payment request to a customer from a merchant. In such an embodiment, the generation of a URL to a customer included with an invoice or statement, may allow for one click payment of the invoice by the customer.

In addition, a customer invoicing system could interface with the Billing/Invoicing system 108 and the GMRMS 106 and compare the amount invoiced to a particular customer with the amount set forth in the URL submitted by the customer, in connection with payment. A discrepancy could trigger an alert to the customer, an alert to the merchant (via the message/event notification system 124), or some other action. 108a shows the database, which may be used by a billing/invoicing system to store data.

Section 110 is collectively known as a merchant system, and may include sub sections such as a merchant interface(s), 112, and a Secure API (114). In at least one other embodiment, the system may include reporting systems, invoicing systems, batch summary systems, and other related features For example, if a business owner using an online accounting system, such as Quicken Online, Freshbooks, or Mint, the APIs of the current invention could speak to such systems and enable integration of invoicing data and back-end accounting systems.

Section 120 shows a block of payment gateways. In at least one embodiment, payment gateways 120 allow for secure communication between front-end API enabled payment systems, and the processor networks 130. Section 130 shows a block diagram of the processing networks. It should be noted that a GMRMS system, 106, could potentially connect to either a gateway 120 or directly to a processor 130. Gateways, 120, typically act as a “bridge” between internet enabled and web enabled payment systems, and the processors 130. Gateways 120 themselves may contain customer databases, payment histories, batch detail data, and many other functions. Processors, 130, may include similar functionality to Gateways 120, but are themselves typically responsible for the allocation and distribution of funds from customer and customer's bank account 170 to the merchant's bank account 150.

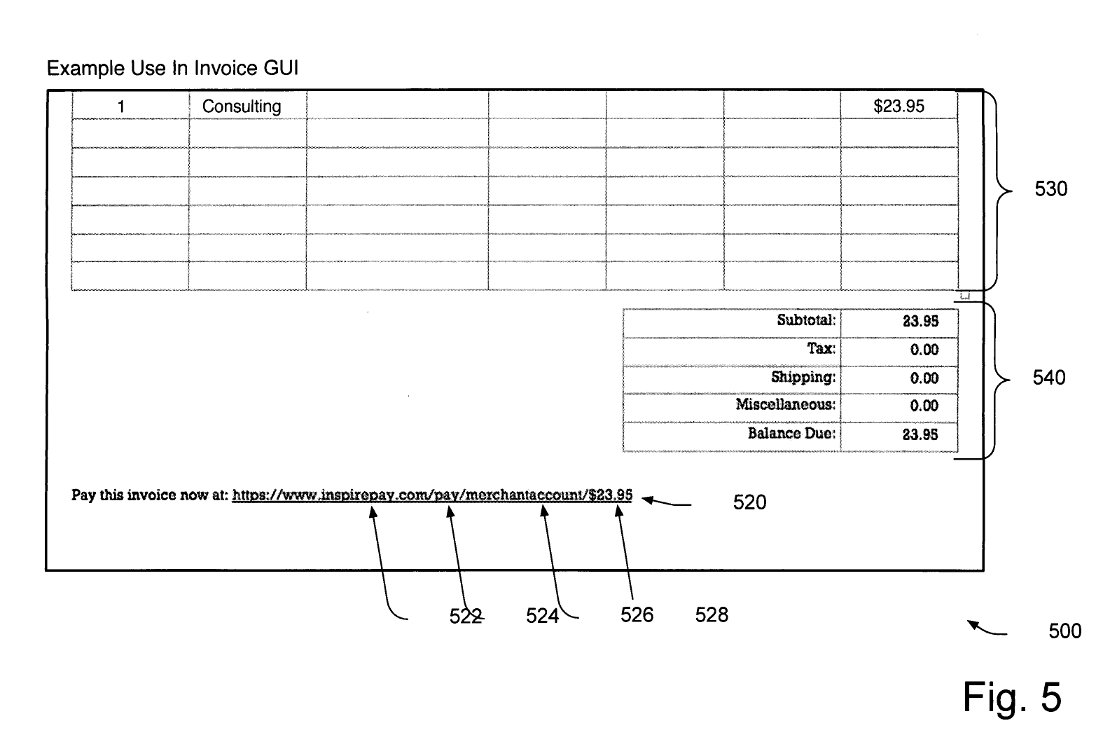

Section 160 refers to a user GUI for potential integration with the URL and the billing/invoicing system 108 in order to provide a merchant with the ability to personalize invoices and other components of the payment system that will be exposed to a customer. A sample GUI for invoicing is set forth in greater details in FIG. 5 The GMRMS 106 handles merchant interface components of the GUI such as merchant logos, colors and fonts. The GUI could also be invoice specific so that a customer of one product of a merchant could receive a different GUI than a customer of another product. As explained above with respect to the GMRMS 106, these additional GUI enhancement modules could be managed by a third party payment provider or by the merchant themselves.

Referring now to FIG. 2, a URL 200 of the present invention is shown. The URL 200 is composed of up to N possible components. Consistent with HTTP standards for interne browsers (such as Internet Explorer™, Firefox™ and Safari™), the current embodiment of the URL would first include a primary domain 201. In this instance, www.inspirepay.com is the primary domain. It is well understood that the www at the beginning of the primary domain 201 could be modified to include additional sub domains such as charity.inspirepay.com or paynow.inspirepay.com for example. Additionally, while the primary domain 201 in this example uses the domain name inspirepay.com, it is also understood that merchants may wish to use their own domain name in order to avoid customer confusion over the identity of the payment page.

The next component(s) of the sample URL 200 are Fields 1-N 202a-202n. As illustrated in FIG. 2, these are the fields that direct the GMRMS 106 regarding the key data fields that can be used to generate one or more payment transactions such customer name, the modality (iPhone. Blackberry, PC, etc), amount, transaction IDs (such as invoice #s), comments, currency, recurring data, or any number of other fields of data that must be entered in connection with the payment process. It is appreciated that the URL could easily be constructed in such a way that it is readable by a customer such as: HTTP://KendallThiessen.AgreesToPay.InspiredCommerce.com/aTotalOf545USdollars/forLegalServicesRenedered/InvoiceNumber223

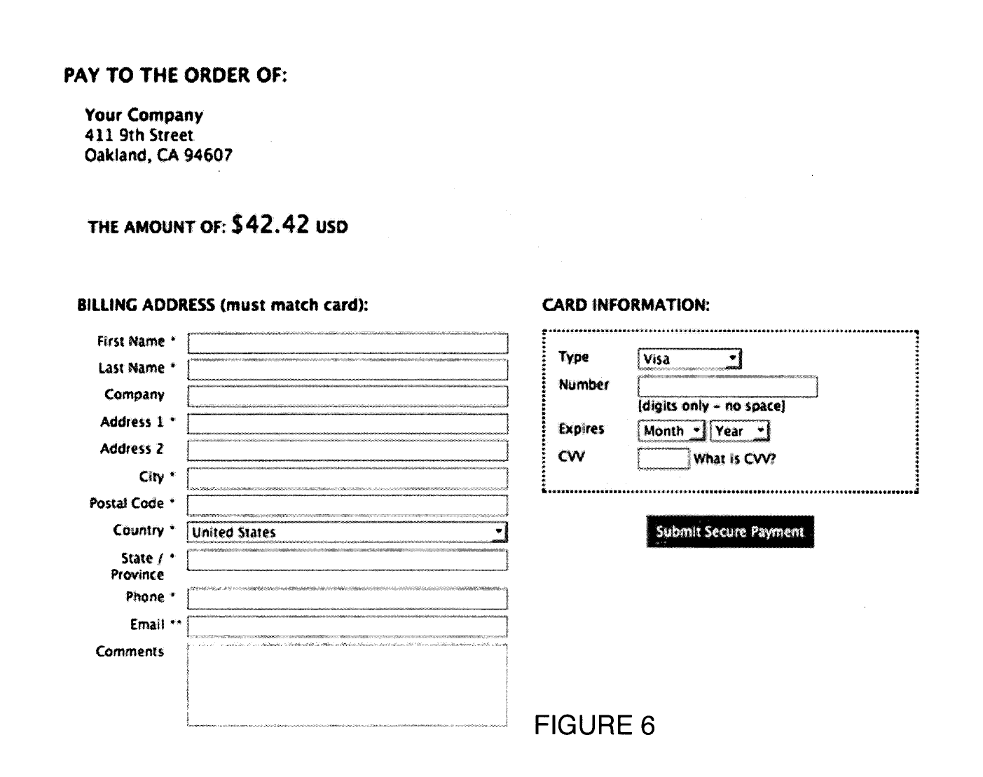

As explained above with reference to FIG. 1, the GMRMS 106 receives this URL 200 and parses it in order to generate a payment page (further illustrated in FIG. 6) for a customer. Since merchants may desire very different fields of data in connection with a payment transaction, a URL 200 could also include one or more particular merchant IDs in fields 202a-202n that could trigger the GMRMS 106 to retrieve a URL field “map” (not shown). Such a map would provide a mapping between the fields in the URL and the Billing/invoicing system 108 such that each merchant could uniquely configure each field 202a-202n in the URL 200.

Referring now to FIG. 3, a sample list of message/notification methodologies are provided. Each of the methods set forth in FIG. 3 including emails, text messages, and phone calls (including automated voice systems) could be utilized by the message notification system 124 to a customer and/or a merchant in connection with the invoicing to or payment by the customer. It is also possible to share a URL of the present invention across any number of social media platforms including Facebook, twitter, LinkedIN, or SMS. In each instance, the link would be used to generate a merchant/customer specific invoice page based on the components of the link itself.

Referring now to FIG. 4, a sample use of the URL in connection with an email message is shown. In this instance, the message notification system 124 is generating an invoice to a customer. As soon as the customer submits the URL on an interne enabled device (such as by clicking on it), the customer would be brought to the payment page (including associated GUI) that has been configured for “pay” (field 1 202a) to “merchantaccount” (field 2 202b). The payment page would be pre-populated with $23.50 (field 3 202c) as that is the payment amount set forth in the URL. The merchant could determine whether one or more of the fields 202l-202c in this sample URL could be modified by the customer. For example, the customer could be permitted to modify the payment amount and would still be provided with a relevant payment URL. Alternatively, the URL in FIG. 4 could be effective only in the event that the amount in the URL sent in the email matches the URL submitted by the customer. In this way, various payment controls (or payment flexibility) could be easily implemented by the merchant simply by modifying the fields in the URL.

Referring now to FIG. 5, a sample invoice GUI 500 is shown. The invoicing/billing system 108 could either populate this GUI or could be configured to generate the URL based on an already populated invoice provided by the merchant. As explained above, this invoicing/billing system could be configured by the merchant or by a third party payment provider. In this example, the invoice includes an explanation of products/services 530, the amount being invoiced including applicable taxes 540 and a URL of the present invention that has been modified to reflect the fields used by the merchant and compatible with the GMRMS 106.

Referring now to FIG. 6, a sample payment page 600 is shown. Once again, the payment page 600 could be configured to reflect any number of different GUIs such that it reflects the unique branding and identity of the merchant. The customer would complete this page and enter appropriate credit card information in connection with a payment. While each payment made by the customer could require re-entry of all payment information, the customer could also permit the saving of one or more of the payment fields in connection with a payment to that same merchant, or if this payment page is hosted by a third party payment provider, in connection with another merchant that is also using the same third party payment provider. In this way, the customer would not be required to enter payment information on each transaction. Once the customer has completed each of the fields on the payment page 600, they would simply click submit and the payment amount would be debited from the customer bank account or charged against their credit card (or other payment methodology) 170 and credited to the merchant's bank account 150 through one or more gateways 120 or processors 130. Submission could further include one or more messages/event notifications being sent to the customer and/or merchant by the message/event notification system 124.

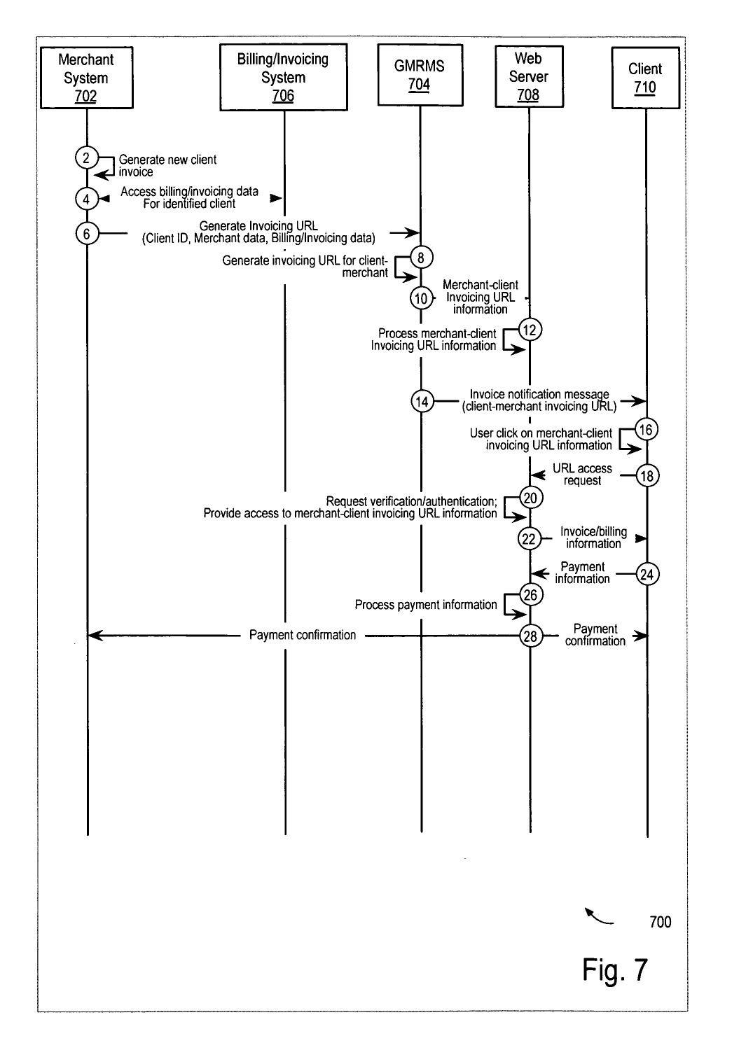

Referring now to FIG. 7, a flowchart illustrating one embodiment of the payment method of the present invention is shown. The method begins in Step 2 with Merchant System 702 generating a new client invoice. As explained above, the invoice generated in Step 2 could be an actual invoice with populated data that could be data scraped for payment information or could instead be the actual payment data that is be accessed in Step 4 by the billing/invoicing system 706 to generate an invoice. In either case, the Billing/Invoicing system uses the relevant billing data and sends one or more invoicing fields to the GMRMS 704. Specifically, following receipt of the data in Step 6, in Step 8, the GMRMS uses the invoice data to generate a merchant specific URLs. As explained above with reference to FIG. 1, the GMRMS 704 uses the merchant-client URL information in Step 10 to determine which fields will be used in the URL and their respective ordering. The GMRMS 704 then sends the merchant-client Invoicing URL information to the web server in Step 10. In Step 12, the web server 708 processes the merchant-client URL to set up permissions, and otherwise enable dynamic generation of a payment page responsive to receipt of a request for the merchant-client URL page(s). Following processing by the Web Server 708, an invoice notification that includes the applicable merchant-client URL is generated by either the GMRMS, the Billing/Invoicing system 706 or the Merchant System 702 and sent to the client 710.

Upon submission by the client 710 of the merchant-client URL in Step 16, a URL access request is generated in Step 18 to the web server 708. Thereafter, in Step 20, either the web server 708 or the web server in conjunction with the GMRMS and/or the Billing/Invoicing system verifies and authenticates the URL. This could include, for example, verifying the accuracy of one or more fields and matching the merchant-client URL requested with the merchant-client URL processed in Step 12.

Assuming that the merchant-client URL is verified, the web server in Step 22 dynamically generates an invoicing page. Step 22 could include the additional steps of retrieving one or more merchant GUI components such as company name, address, colors, fonts or other elements that are part of the merchant GUI in connection with the generation of a dynamically generated web page. Alternatively, in Step 22 the web server could simply retrieve a previously generated web page that was stored on the web server 708 during Step 12.

The page retrieved or created in Step 22 is then presented to the client 710 who then enters payment information on the web page in Step 24. Step 24 could include entry of a payment page such as one set forth in FIG. 6 or could instead provide access to previously entered payment information responsive to the entry of a user name and/or password. This page could further include one or more flags or fields for enabling partial pay, full pay, deferred pay or otherwise allocation some portion of that invoice to a second user. For example, if an invoice was for professional services, it may be that one half is paid by one company and the other half us to be allocated to a second company. The invoicing page could include such additional “allocation” functionality. Once payment information is submitted (such as via a submit payment button), the payment is processed in accordance with standard payment procedures in conjunction with one or more gateways 120 or processors 130 in communication with the web server 708.

Finally, in Step 28, payment is confirmed and payment details may be provided to the Billing/Invoicing system 706, the GMRMS 704, the client 710 and the merchant system 702 via the message/event notification system, 124 (FIG. 1).

One or more different inventions may be described in the present application. Further, for one or more of the invention(s) described herein, numerous embodiments may be described in this patent application, and are presented for illustrative purposes only. The described embodiments are not intended to be limiting in any sense.

One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations.

Particular features of one or more of the invention(s) may be described with reference to one or more particular embodiments or figures that form a part of the present disclosure. These particular features are shown by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s), nor a listing of features of one or more of the invention(s) that must be present in all embodiments.

I claim:

1) a system for enabling online payment comprising:
a. A payment database for storing merchant and customer information regarding a financial transaction;
b. A computer server capable of delivering one or more pages of content to a requesting device responsive to receipt of an internet link;
c. A software parsing application, in communication with the computer server and payment database, for parsing the internet link received by a computer server;
d. A merchant interface, logically connected with the payment database, for importing data regarding a customer or a transaction;
e. A customer payment interface, generated by the software parsing application in response to the information received via the internet link and logically connected to the payment database and a payment gateway, for enabling submission and processing of one or more payment requests.

2) The system of claim 1, further comprising a messaging system for transmitting a success message to a merchant and customer following successful submission of payment information via the customer payment interface.

3) The system of claim 1, further comprising a general user interface module, logically connected to the software parsing application, for mapping one or more visual interface components associated with a merchant such that the customer payment interface generated by the software parsing application includes the appropriate visual components.

4) The system of claim 1, wherein the merchant interface is a secure application programming interface (API) allowing for secure communication between a merchant accounting system and the payment database.

5) The system of claim 1, wherein the software parsing application is the Grammatical Monetary Request Management System (GMRMS).

6) The system of claim 5, wherein the GMRMS parses the internet link by retrieving a map of invoice fields from the payment database.

7) The system of claim 5, wherein the invoice fields in the internet link are parsed in accordance with a standard internet link format.

8) The system of claim 2, wherein the messaging system transmits a successful payment via short messaging systems over a mobile phone.

9) A method for enabling online payment comprising:
a. Hosting a payment database that includes at least one merchant profile, one customer profile and at least one transaction summary;
b. Generating an internet link that includes merchant, customer and transaction information in a single link responsive to receipt;
c. Responsive to receipt of the internet link by the computer server, Parsing the internet link received by a computer server, and importing profile data regarding at least one customer, merchant, and a transaction as stored in the payment database;
d. Generating a customer payment page using the profile data mapped to the parsed internet link for enabling submission and processing of one or more payment requests by a customer; and
e. Submitting payment information submitted via the customer payment page to a payment gateway for payment processing.

10) The method of claim 9, further comprising, in response to successful submission of payment information via the customer payment page, sending a notification to a customer and merchant confirming successful payment.

11) The method of claim 9, wherein the hosted payment database includes at least one merchant profile with at least one general user interface component associated with such merchant.

12) The method of claim 11, wherein the step of generating a customer payment page includes retrieving one or more general user interface components associated with the merchant in the hosted payment database for use on the page.

13) The method of claim 9, wherein the step of generating an internet link includes generating an internet link that is human readable by a customer.

14) The method of claim 9, further comprising the step of hosting a secure application programming interface in communication with the payment database, for enabling the import of customer or invoice information in an automated fashion.

15) The method of claim 9, wherein the step of parsing the internet link includes verifying the accuracy of one or more fields in such internet link by comparing the data against the customer and merchant profile in the payment database.

16) The method of claim 9, wherein the step of parsing the internet link includes interpreting a flag in the URL to determine if the customer is responsible for paying the transaction fees.

17) The method of claim 9, wherein the step of generating a payment information page includes generating a payment information page that includes an option for allocating at least some portion of said invoice or payment obligation to a second user.
